(19) United States
(12) Patent Application Publication
(10) Pub. No.: US 2010/0186484 A1
(43) Pub. Date: Jul. 29, 2010

(54) Apparatus and Method for Isolating or Testing a Pipe Segment with Axial Reinforcement

(75) Inventor: Glenn Carson, Sarnia (CA)

Correspondence Address: CAHN & SAMUELS LLP, 1100 17th STREET NW, SUITE 401, WASHINGTON, DC, 20036, US

(73) Assignee: CAR-BER INVESTMENTS INC., Point Edward, ON (CA)

(21) Appl. No.: 12/376,740

(22) PCT Filed: Aug. 7, 2007
(86) PCT No.: PCT/CA07/01379

§ 371 Date: Feb. 6, 2009

Related U.S. Application Data
(60) Provisional application No. 60/821,681, filed on Aug. 7, 2006.

(51) Int. Cl. G01M 3/28; F16J 15/02

(52) U.S. Cl. 73/49.8; 277/625; 277/314

(57) ABSTRACT

An apparatus and method for testing the integrity of a weld securing a flange to the end of a pipe comprises a testing assembly and a reinforcement assembly. The testing assembly comprises a first sealing means positioned within the pipe and a second sealing means secured against the flange face to form a sealed region within the pipe with the region overlapping the weld. The reinforcement assembly comprises a circumferential clamp secured to the outer wall of the pipe and an anchor plate positioned opposite the flange. The first sealing means is connected to the anchor plate to prevent relative movement there-between. The anchor plate is connected to the clamp to prevent relative movement there-between. The weld test procedure comprises installing the apparatus, filling and pressurizing the sealed space and monitoring the pressure created therein. The reinforcement assembly prevents the first sealing member from being separated and allows a weld test to be performed without a compressive force being applied on the weld. The invention also provides a reinforced tool and method for isolating an end segment of a pipe.

### I. FIELD OF THE INVENTION

The present invention relates to apparatus and methods for isolating a pipe segment or for testing welds joining a flange to the end of a pipe. More specifically, the invention provides an apparatus and method for isolating and/or testing a pipe segment wherein a means for axial reinforcement is provided.

### II. BACKGROUND OF THE INVENTION

In chemical or petrochemical plants etc., it is often necessary to convey fluidic materials from one location, or holding cell to another. The conveyance of such material normally includes equipment such as conduits or pipes, storage or reaction vessels etc., which are generally manufactured from metal. The joining of separate pieces of the conveying equipment is generally achieved by welding the necessary pieces together. For example, when joining adjacent ends of pipe together, it is common for each end to be provided with flanges, welded to each respective end, which are then bolted together to form a seal. As will be appreciated by persons skilled in the art, such welded joint must form a complete seal so as to prevent leakage of the materials being transported. This is particularly the case when handling potentially hazardous (i.e. flammable) or toxic materials.

For reasons of safety, it is often necessary to periodically test the integrity of the welds used in joining the various pieces of equipment (such as pipes, vessels, flanges and the like) together. The prior art teaches various tools for conducting weld integrity tests on conduits. For example, U.S. Pat. Nos. 6,131,441 and 5,844,127 (Berube and Carson) (the entire disclosures of which are incorporated herein by reference) teach weld testing tools which isolate a particular section of a pipe (for example, a section including a weld) and subject the section to a high pressure fluid within a constrained annular space defined by the tool and the inner surface of the pipe. The pressure of the fluid within the annular space is monitored whereby any pressure drop signifies a leak in the weld. Such tools may also be used solely for the isolation of the pipe section without any test being conducted. Such isolation is often necessary when welding a pipe etc. that had previously contained flammable materials. In such cases, it is important to separate any fumes of such material from the weld area. The tools mentioned above can be secured against the inner wall of a pipe at a given distance from the weld area and act as a barrier to the fumes contained along the remaining length of the pipe. To prevent any fume accumulation, and the concomitant pressure build up, the tools of the '441 and '127 patents may be provided with a vent pipe to allow such fumes to escape past the weld area without coming into contact with such area. The tools provided in the '441 and 127 patents can be positioned along the length of any pipe or similar conduit.

U.S. Pat. No. 5,027,079 (Dufort) provides another test tool specifically adapted for testing the integrity of welds on a flanged pipe. As taught in the '079 patent, the test tool includes a sealing end having a radially expanding bladder that is positioned a given distance from a weld area and inflated. Pressurizing the bladder in such manner causes the tool to frictionally engage the inner wall of the pipe thereby securing the tool in position and isolating the weld region from the remainder of the pipe. The tool also includes a flange plate for securing against the flange on the pipe and for forming a sealed region between the flange and the sealing end of the tool with such region containing the weld to be tested. The sealed region is pressurized with a test fluid and the pressure monitored for leaks.

Although the above-described references provide efficient tools for testing welds, they are designed to apply mainly a radial force against the weld. However, there exists a need for exerting further stresses on welds for providing a “worst case scenario” so that such welds can be tested under extreme conditions. More particularly, there exists a need to conduct weld tests while allowing an axial expansion force to be subjected on the welds being tested.

In addition, with at least some of the known isolation and/or testing tools, a buildup of pressure upstream of the tool (due to accumulation of fumes etc.) may result in the “blow out” of the tool wherein the tool is explosively displaced from the pipe, generally in the axial direction (with reference to the pipe). Thus, there exists a need for providing a pipe isolation and/or testing tool with reinforcement to prevent displacement of such tool in the axial direction.

### III. SUMMARY OF THE INVENTION

In one aspect, the present invention provides a weld testing apparatus for testing the integrity of a weld joining a flange to an end of a pipe, the apparatus, when in use, comprising:
a) a testing assembly comprising:
   a first sealing means for forming a seal within the pipe;
   a second sealing means for sealing the flange;
   a means for pressurising a region bounded by the first sealing means, the second sealing means and the inner wall of the pipe; and
   the testing assembly including a vent extending there-through; and,
b) a reinforcement assembly for securing the testing assembly, the reinforcement assembly comprising:
   a clamp secured to the outer wall of the pipe;
   an anchor plate spaced apart from the clamp and positioned opposite the flange;
   a first anchoring means connecting the anchor plate and the first sealing means for preventing separation between the anchor plate and the first sealing means; and
   a second anchoring means connecting the anchor plate and the clamp for preventing relative movement there-between.

In a further aspect, the invention provides, a method of testing the integrity of a weld joining a flange to an end of a pipe comprising:
securing a first sealing means within the pipe;
securing a second sealing means against the flange;
establishing a sealed region within the pipe bounded by the first and second sealing means and the inner wall of the pipe, the sealed region comprising the weld;
providing a clamp for frictionally engaging the outer wall of the pipe;
providing an anchoring means opposite the flange;
connecting the anchoring means to the clamp to prevent relative movement there-between;
connecting the anchoring means to the first sealing means to prevent relative movement there-between; and,
   filling and pressurizing the sealed region with a testing fluid.

In a further aspect, the invention provide an apparatus for isolating an end of a pipe comprising:
a) an isolation assembly comprising:
   a sealing means for forming a seal within the pipe;
      and,
b) a reinforcement assembly for securing the isolation assembly, the reinforcement assembly comprising:
   a clamp secured to the outer wall of the pipe;
   an anchor plate spaced apart from the clamp and positioned opposite the end of the pipe;
   a first anchoring means connecting the anchor plate and the sealing means for preventing axial displacement of the sealing means within the pipe; and
   a second anchoring means connecting the anchor plate and the clamp for preventing relative movement there-between.

In another aspect, the invention provides a method of isolating an end segment of a pipe comprising:
securing a sealing means within the pipe to isolate the end segment from the remaining interior portion of the pipe;
providing a clamp for frictionally engaging the outer wall of the pipe;
providing an anchoring means opposite the pipe end segment;
connecting the anchoring means to the clamp to prevent relative movement there-between;
connecting the anchoring means to the sealing means to prevent axial displacement of the sealing means within the pipe.

### IV. BRIEF DESCRIPTION OF THE DRAWINGS

These and other features of the invention will become more apparent in the following detailed description in which reference is made to the appended drawings wherein:

FIG. 1 is a partial cross sectional view of a testing tool according to an embodiment when in use with a pipe.

FIG. 2 is an end view of FIG. 1 taken along the line 2-2.

FIG. 3a is an end view of FIG. 1 taken along the line 3-3 according to one embodiment.

FIG. 3b is an end view of FIG. 1 taken along the line 3-3 according to another embodiment.

FIG. 4 is a partial cross sectional view of a testing tool of FIG. 1 according to another embodiment.

FIG. 5 is a partial cross sectional view of a testing tool of the invention according to another embodiment.

FIG. 6 is a cross sectional view of the vent pipe and first sealing apparatus of the apparatus of FIG. 5.

FIG. 7 is a cross sectional view of a variant of the apparatus of FIG. 6.

FIG. 8 is a partial cross sectional view of the testing tool of FIG. 5 according to another embodiment.

FIG. 9 is a partial cross sectional view of the testing tool of FIG. 5 according to another embodiment.

FIG. 10 is a partial cross sectional view of the testing tool of FIG. 5 according to another embodiment.

FIG. 11 is a partial cross sectional view of an isolation apparatus according to another embodiment of the invention.

FIG. 12 is a partial cross sectional view of a variation of the apparatus of FIG. 11.

FIG. 13 is a partial cross sectional view of a variation of the apparatus of FIG. 1.

FIG. 14a is a schematic cross sectional view of the sealing apparatus of FIG. 12.

FIG. 14b is a schematic cross sectional view of a variation of the apparatus of FIG. 14a.

### V. DETAILED DESCRIPTION OF THE INVENTION

Throughout the description of the invention the following terms will be assumed to have the following associated meanings:

“Pipe”—will be understood to mean any pipe or pipe-like conduit of any length to which is a flange is capable of being attached. Although the invention is directed to metal pipes to which flanges are welded, it will be understood that the invention may equally be applicable to pipes of other material, such as PVC etc. Thus, the term “pipe” will be assumed to comprise straight or curved conduits and tubular connections between other equipment or apparatus such as ports provided on vessels etc. and “T” junctions etc. For convenience, the present disclosure and accompanying figures show and describe a length of a straight pipe.

“Annular”—this term is used to describe a body having at least one outer diameter and at least one inner diameter. Thus, an “annular tube” will be assumed to be a hollow tube with an inner and outer diameter. An “annular disc” will be assumed to be an object having an outer diameter and a central aperture thereby providing an inner diameter.

“Axial”—this term will be used to describe a direction taken along the longitudinal axis of a pipe or conduit. Thus, “axial force” or “axial stress” will be understood as being a force (either expansive or compressive) applied in a direction parallel to the longitudinal axis of the conduit.

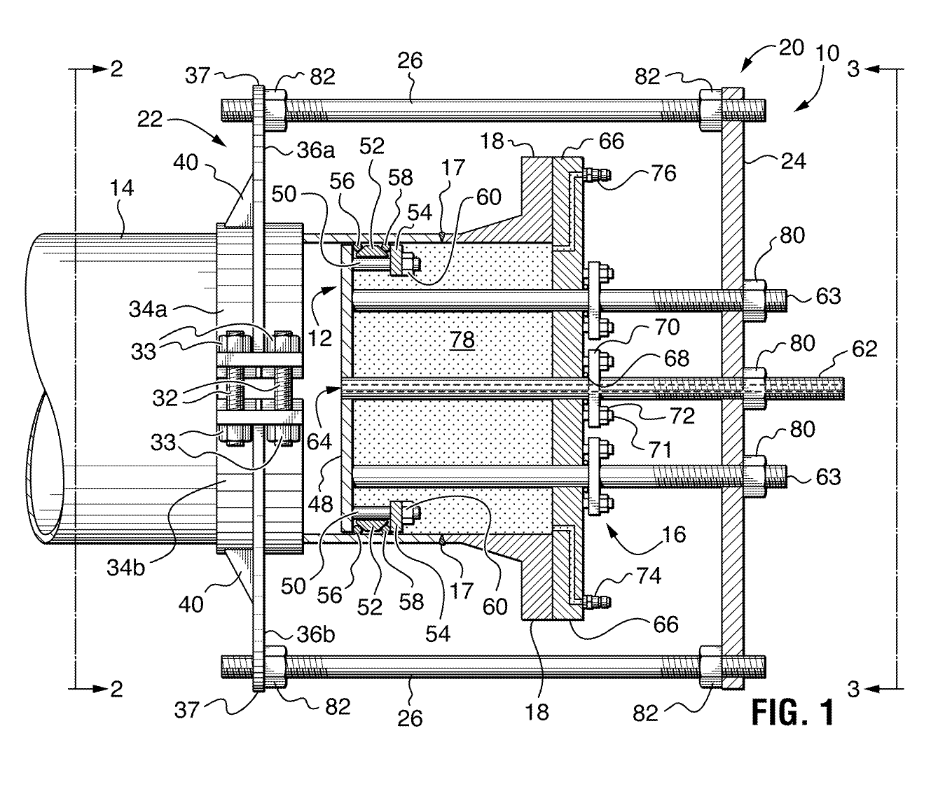

As shown in FIG. 1, the apparatus of the invention 10 according to one embodiment of the invention includes a testing assembly comprising a first sealing means 12 for positioning within a pipe 14 and a second sealing means 16 for positioning against the outer face of a flange 18. The flange 18 is joined by a weld 17, which is to be tested by the present invention. The first sealing means 12 establishes a seal against the inner wall of the pipe 14. The second sealing means 16 establishes a seal against the outer face of the flange 18. The apparatus also includes a reinforcement assembly 20, which anchors the testing assembly in the desired position. The reinforcement assembly 20 comprises a circumferential clamp 22 and an anchor plate 24. The anchor plate is connected to the clamp 22 by means of two or more anchor rods 26.

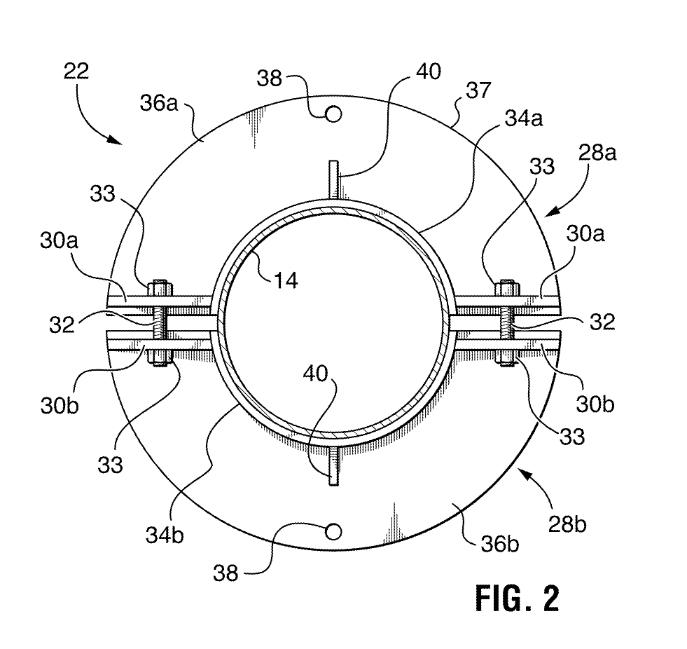

Examples of circumferential clamps 22 as used in the present invention are provided in applicant's co-pending PCT publication number WO2006/069446 (the entire contents of which are incorporated herein by reference). As shown in FIG. 2, the clamps 22 generally comprise a clamshell structure and may be comprised of two or more sections (for example, large diameter pipes may require more sections due to the overall weight of the clamp) 28a and 28b. The sections include clamping flanges 30a and 30b, respectively, having apertures through which extend bolts 32. Cooperating nuts 34 secure the sections together. Any number of bolts 32 and nuts 34 may be provided. The sections 28a and 28b include a collar portion 34a and 34b respectively, which combine to generally circumferentially engage the outer surface of a pipe 14. As will be understood, once the collar portions 34a and 34b are positioned, the bolts 32 and nuts 33 are inserted through the apertures on the clamping flanges 30a and 30b, whereby tightening of the nuts 33 forces the collar portions 34a and 34b to bear against the outer surface of the pipe 14 thereby resulting in a tight fitting engagement. The degree of torque required to provide the desired level of engagement between the clamp 22 and the pipe 14 will be apparent to persons skilled in the art having regard to the present disclosure. It will also be appreciated that although each of the sections is shown to have generally opposite flanges, it will also be possible for one pair of the flanges, and the associated bolt 32 and nuts 33, to be replaced by a hinge (as described in PCT publication number WO2006/069446).

It will be understood that the term “circumferential clamp” as used herein is not meant to be limited to clamps that encircle the entire circumference of a pipe. For example, as shown in the figures, one clamp may be used for a variety of different pipe diameters by increasing the lengths of the bolts 32. Thus, the term “circumferential” is meant to describe a clamp that frictionally engages at least a portion of the circumference of a pipe.

In addition, for convenience, the present disclosure makes reference to a single clamp being provided on the outer surface of the pipe 14. However, it will be appreciated that more than one clamp may be used in situations where added reinforcement is required. Further, the engagement means for the clamp is described as being effected by nuts and bolts 33, 32. However, as described in the aforementioned PCT publication, closure of the clamp may be achieved with magnetic, hydraulic or any other such means. As will be understood, the purpose of the clamp is to frictionally engage the outer wall of the pipe 14 being tested and to serve as a reinforcement to prevent movement of the apparatus, in particular, movement in the axial direction.

The clamp sections 28a and 28b each also include a flange 36a and 36b, respectively, extending generally perpendicularly to the collar portions 34 a, b. When the clamp sections are joined in position over a pipe 14, the flanges 36a and 36b combine to form a support flange 37 that extends generally perpendicularly from the collar portion and generally orthogonal to the longitudinal axis of the pipe 14. The support flange 37 includes two or more apertures 38 for receiving the anchor rods 26 as will be described further below.

The clamp sections 28 a, b are preferably also provided with a number of braces 40 to maintain the relative positioning of the collar portions 34 a, b and the respective flanges 36 a, b and to support the flanges 36 a, b. As will be understood, the need for and number of such braces will depend on the gauge of steel used to manufacture the clamp and also on the diameter of the clamp and various other factors.

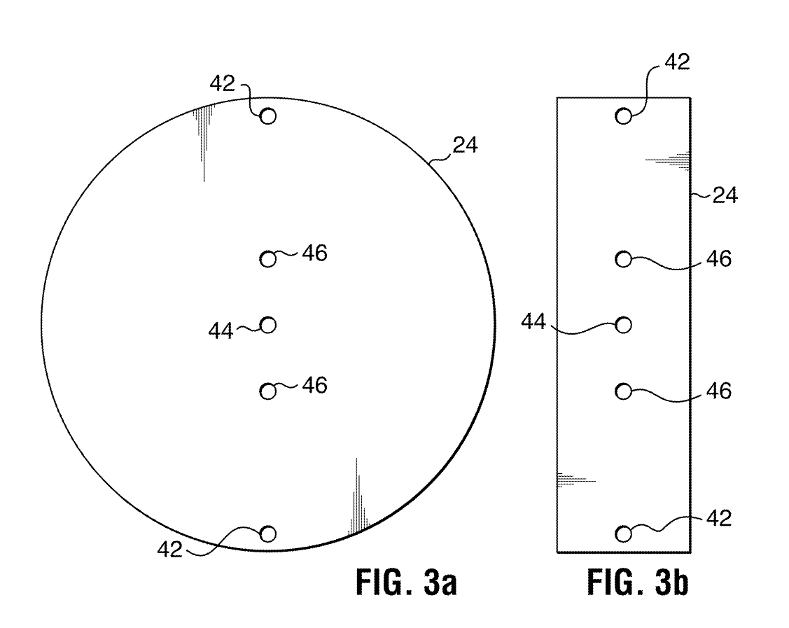

As indicated above, opposite the circumferential clamp 22, the reinforcement assembly includes the anchor plate 24. As shown in FIGS. 3a and 3b, the anchor plate may be either generally disc shaped (FIG. 3a) or may comprise a generally rectangular plate (FIG. 3b). The anchor plate 24 is provided with two or more first apertures 42 for receiving the anchor rods 26. As will be understood, the number of apertures 42 provided on the anchor plate will depend upon the number of anchor rods required. Thus, for larger diameter pipes, more than two rods may be needed. Further, it will be appreciated that should more than two anchor rods be needed, the anchor plate will assume a disc shaped structure (as in FIG. 3a) while the use of two anchor rods will only require a rectangular shaped anchor plate (as in FIG. 3b). It will also be appreciated that a disc shaped anchor plate will be greater in weight than a rectangular shaped plate.

The anchor plate 24 is also provided with a generally centrally located vent aperture 44 for receiving a vent pipe of the testing assembly (as will be described further below). Further, the anchor plate 24 may also include one or more support apertures 46 for receiving tie rods provided on the testing assembly (as described further below).

As illustrated in FIG. 1, the clamp 22 and the anchor plate 24 are aligned so as to allow both ends of the anchor rods 26 to pass through the respective apertures. As also shown, in a preferred embodiment, the support flange 37 of the clamp 22 and the anchor plate 24 are sized to be larger than the diameter of the flange 18 so as to allow the respective engagement of the anchor rods.

As illustrated in FIG. 1, the testing assembly comprises a first sealing means 12. The first sealing means 12 includes a sealing plate 48 being adapted to be received within the lumen of the pipe 14. The diameter of the sealing plate 48 is less than the inner diameter of the pipe 14. The sealing plate is provided with a plurality of circumferentially spaced bolts 50. Bolts 50 may be permanently secured to the sealing plate 48 by welds or by nuts (not shown). As will be appreciated, the bolts 50 may be secured to the plate 48 by any means known to persons skilled in the art. The first sealing means 12 also includes an annular ring 52 and an annular bearing plate 54. Resilient seals 56 and 58, such as O-rings and the like, are provided between the sealing plate 48 and the annular ring 52 and between the annular ring 52 and the bearing plate 54, respectively. As shown, the bolts 50 extend through apertures (not shown) provided on the bearing plate 54 and are secured by cooperating nuts 60.

As can be seen, when the components of the first sealing means 12 are in position, tightening of the nuts 60 causes the sealing plate and the bearing plate 54 to advance towards each other. Such action causes deformation of the resilient seals 56 and 58. Such deformation is diverted radially outwardly so as to force the seals to impinge against the inner wall of the pipe 14. In such manner, two seals are formed between the first sealing means 12 and the inner wall of the pipe 14. In a preferred embodiment, the outer edges of the annular ring 52, adjacent the wall of the pipe 14, are inwardly bevelled so as to assist in such radially outward deformation of the seals. However, various other methods may be used to cause such directed deformation. For example, the ring may be provided with a ledge to prevent inward deformation of the seals and, thereby, force any deformation to take place in the outward direction only. Further, although the embodiment of bolts 50 and nuts 60 is described in the present description, it will be appreciated that any bearing method may be used to advance the sealing plate and bearing plate together. For example, instead of a mechanical means such as the use of nuts and bolts, a hydraulic means may be used. In such case, the bolts may be replaced with hydraulic cylinders. Various other force applying means will be known to persons skilled in the art.

The sealing plate 48 of the invention is further provided with a vent pipe 62 extending from a central opening 64 provided on the plate 48. The vent pipe 62 may be welded or bolted on to the sealing plate 48 or connected thereto using any other means. The vent pipe 62 serves to provide a communication route between opposite sides of the testing assembly and, thereby, as a passage to vent any fumes or gases etc. contained in the pipe there-through. In a preferred embodiment, one vent pipe is provided. However, as will be appreciated by persons skilled in the art, any number of vents may be used when needed or desired.

In one embodiment, the sealing plate 48 may also be provided with one or more tie rods 63 extending in the same direction as the vent pipe 62. The tie rods are generally solid and are secured to the sealing plate 48 in any manner as with the vent pipe 62. In one embodiment, the tie rods may be welded to the sealing plate.

Opposite the first sealing means 12, the testing assembly includes the second sealing means 16. The second sealing means 16 includes a generally disc shaped blind flange 66 that is secured to the outer face of the flange 18 using the boltholes normally provided on the flange. For convenience, the bolts and nuts securing the blind flange to the flange 18 are not shown but will be apparent to persons skilled in the art. Also not shown are the commonly known seals used to form a seal between the blind flange 66 and the flange 18. Such seal generally comprises a gasket or the like provided between the opposing faces of the blind 66 and the flange 18.

The vent pipe 62 and the tie rods 63 extend through openings provided on the blind flange 66. Such openings may be sealed by any means such as with resilient sealing members such as O-rings or with packing glands etc. In the embodiment shown in FIG. 1, an O-ring is provided around the circumference of each of the vent pipe 62 and the tie rods 63 along with a shaft seal plate. This is shown with reference to the vent pipe 62 wherein the O-ring is shown as element 68 and the shaft seal plate as element 70. The seal is formed by providing two or more bolts 71 connected to outer face of the blind flange 66 and extending outwardly (i.e. away from the flange 18) therefrom. The shaft seal plate 70, containing openings to receive the vent pipe 62 and the bolts 71, is then placed in position. Nuts 72 are then provided on the bolts 71 and sufficiently tightened to form the required seal. As explained above, similar sealing means are provided on each tie rod 63 as well, where present. In another embodiment, the bolts 71 may be omitted by providing the vent pipe 62 (or the tie rods 63) with threaded outer walls. In this manner, the shaft seal plate 70 may be secured to the blind flange with a nut that cooperatively engages the threaded outer wall of the vent pipe 62. Various other methods will be known to persons skilled in the art for sealing the openings in the blind flange through which the vent pipe 62 and tie rods 63 extend. Further, although individual shaft seal plates 70 are shown in FIG. 1, it will be understood that in other embodiments, a single plate, having openings to receive the vent pipe 62 and tie rods 63, may be used. It will also be understood that the shaft seal plate 70 or plates may have any shape such as a disc or a rectangle.

The blind flange 66 is further provided with at least one fill port 74 and at least one vent port 76. Each of fill port 74 and vent port 76 comprise a channel through the blind flange 66. Such channels serve to allow a pressurizing fluid to fill and vent, respectively, the test region 78 formed between the first sealing means 12, the blind flange, and the inner wall of the pipe 14. The fill port 74 is connected to a source of pressurized fluid (not shown). The vent port 76 serves to assist the venting of air within the test region 78 when the filling operation is commenced. Once all air is vented, the vent port 76 may be closed to allow the test region 78 to be pressurized, as discussed further below. It will be understood that the configuration of the fill and vent ports may be varied depending on the size of the blind flange 66.

As illustrated in FIG. 1, the external ends of the vent pipe 62 and tie rods 63 are threaded so as to receive nuts 80. The nuts 80 serve to secure the vent pipe 62 and tie rods 63 to the anchor plate as will be described further below.

As also shown, both ends of the anchor rods 26 may be provided with threaded outer walls to receive cooperating nuts 82 as also will be described further below.

The method of the invention will now be described in reference to the apparatus of FIG. 1. The first step in the method, according to one embodiment, involves the installation of the sealing assembly. In this process, the first sealing means 12 is first inserted into a pipe 14 having a weld to be tested, wherein such weld serves to connect a flange 18. The first sealing means 12 is inserted upstream of the weld so that the weld lies between the first sealing means and the flange 18. Prior to inserting the first sealing means 12, the sealing plate 48, ring 52, bearing plate 54, the seals 56 and 58, and the nuts 60 may first be pre-assembled in a loose state and then inserted together into the pipe 14. Once in the desired position, the nuts 60 can then be tightened so as to form the required seals with the pipe 14 inner wall. Alternatively, the various components may be inserted into the pipe 14 separately and connected in situ.

Once the first sealing means 12 is positioned and secured in a sealing arrangement with the pipe inner wall, the second sealing means 16 is then installed. In this process, the blind flange 66 of the second sealing means is first secured to the flange 18 outer face. As indicated above, a gasket or other such sealing means is provided between the flange 18 and the blind flange 66 to form a seal there-between. As also explained above, the blind flange 66 is provided with a plurality of bolt holes corresponding to bolt holes normally provided on the flange 18. Thus, when mounting, the blind flange 66 is oriented so as to allow passage of the flange bolts, the vent pipe 62 and the tie rods 63 through their respective openings. Once the blind flange 66 is in position, nuts are provided and tightened for securing the blind flange 66 to the flange 18 outer face. Following this, one or more seals 68 and shaft seal plates 70 are positioned over the respective vent pipe 62 and, where present, the tie rods 63. The required nuts 72 are then provided and tightened to seal the openings provided in the blind flange to receive the vent pipe 62 and tie rods 63. At this stage, the sealing assembly is installed and a pressure test of the weld 17 may be started. However, according to the invention, prior to commencing such test, the reinforcing assembly 20 should also be installed.

In installing the reinforcement assembly 20, the circumferential clamp 22 is first provided on the outer wall of the pipe 14. As indicated above, the clamp 22 is generally provided in two cooperating sections around the circumference of the pipe 14. The clamp 22 is preferably positioned further upstream on the pipe than the first testing means. Once the clamp 22 is in the desired position, the nuts 33 are tightened so as to form a tight frictional fit with the outer surface of the pipe 14. As explained in the present applicant's co-pending PCT publication number WO2006/069446, this type of circumferential clamp is capable of supporting a high degree of axial force.

After the clamp 22 is secured to the outer surface of the pipe 14, the anchor rods 26 are then positioned in the respective holes provided on the clamp's support flange 37. Following this, the anchor plate 24 is then positioned by aligning the anchor plate 24 so as to allow the vent pipe 62, tie rods 63 and anchor rods 26 to pass through their respective openings provided on the anchor plate 24. Once the anchor plate is in position, the nuts 80 are secured on the vent pipe 62 and tie rods 63. No torquing of nuts 80 is required. Following this, the nuts 82 provided on the anchor rods 26 are positioned so as to secure the anchor plate 24.

At this stage, a pressurizing fluid is introduced into the testing region 78 through fill port 74 provided on the blind flange 66. As explained above, during the filling process, the vent port 76 may be used to vent any air contained within the test region 78. Once all air is vented, the vent port may be closed and the filling process continued until a desired pressure is reached within the test region 78. Such pressure is then monitored with a drop in pressure signifying a defect in the integrity of the weld 17.

As will be understood by persons skilled in the art, various features of the invention are apparent in view of the above description. Firstly, the pressure test of the test region 78 is conducted without any compressive force being applied on the weld 17. In this way, an accurate test is conducted. Further, any axial movement of the first testing means 12 is prevented due to its connection to the reinforcement assembly comprising the anchor plate 24 and the circumferential pipe clamp 22. In this manner, the test may be conducted without the possibility of the testing tool “blowing out” from the pipe 14.

As a further feature, it is noted that the seals 56 and 58 of the first sealing means 12 are exposed to the pressurizing fluid within the testing region 78. As such, the pressure of the fluid within the testing region 78 would, therefore, serve to force such sealing members radially outwards thereby further increasing the sealing force between the first sealing means 12 and the inner wall of the pipe 14.

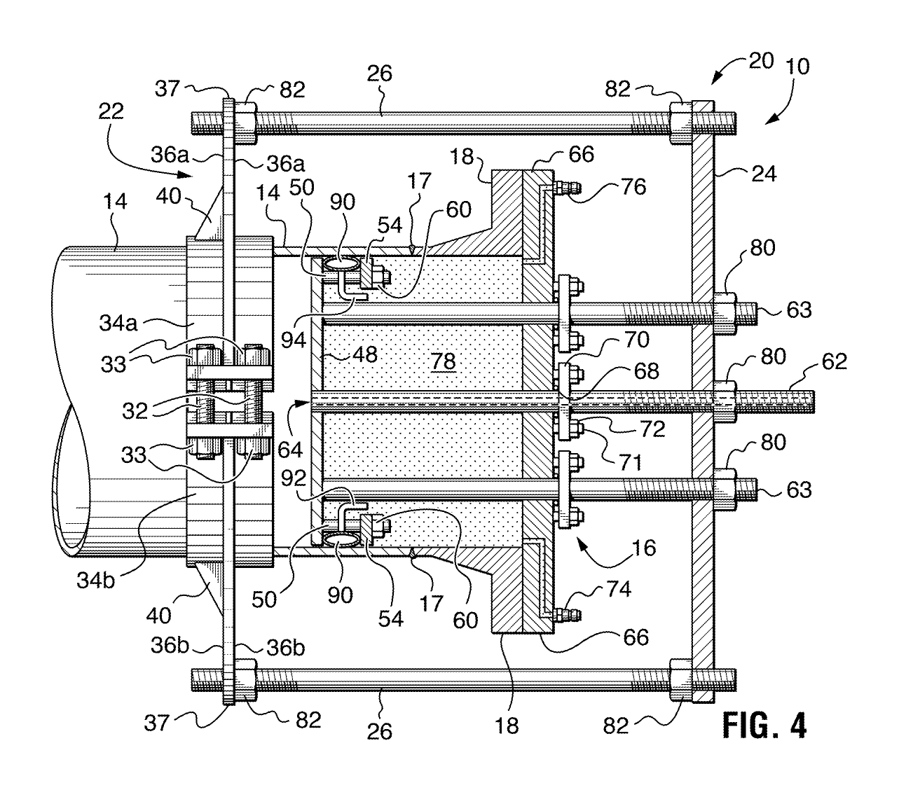

Another embodiment of the apparatus is illustrated in FIG. 4 wherein elements common to those of FIG. 1 are referred to with the same reference numerals. In the embodiment of FIG. 4, a variation of the first sealing means is shown. In this case, the ring 52 and resilient sealing members 56 and 58 are replaced with an annularly shaped inflatable bladder 90. As shown, the bladder 90 is positioned against inner wall of the pipe 14 and is supported in such position by the bolts 50 and the bearing plate 54. As will be understood, the seal in this embodiment is formed by first tightening the nuts 60 until the bladder 90 is in the desired position. A pressurizing fluid (i.e. air, water, hydraulic fluid etc.) is then introduced into the bladder through a bladder fill port 92. In the event that water, hydraulic fluid or other such medium is used instead of air, a vent port 94 is also provided on the bladder to assist in venting any air during the filling operation.

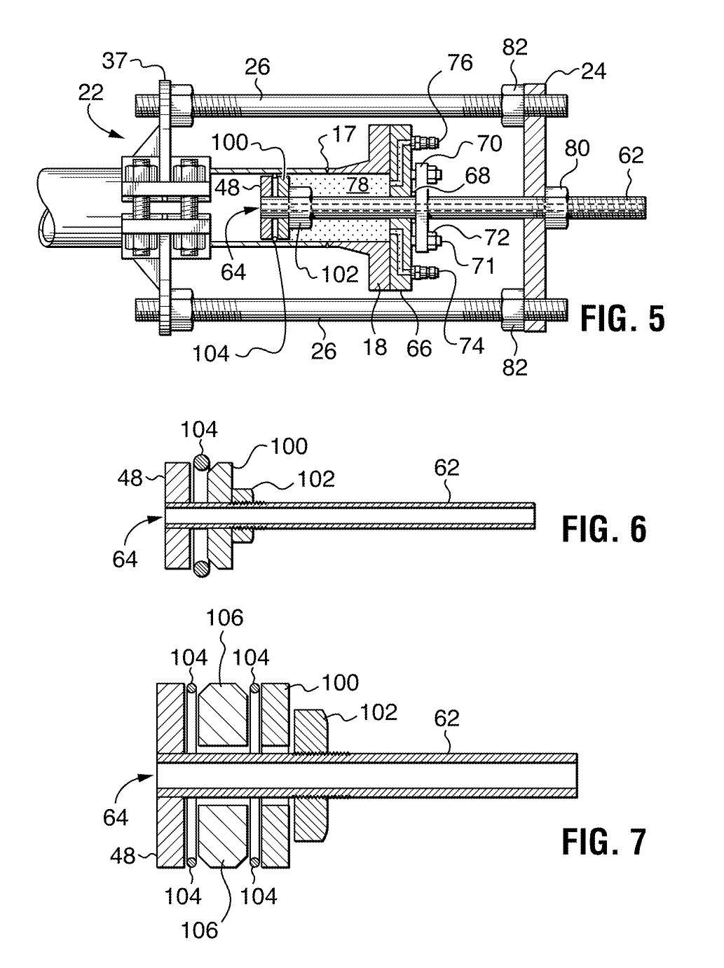

FIG. 5 illustrates another embodiment of the present invention, which is particularly suited for testing smaller diameter pipes and wherein elements common to those of FIG. 1 are referred to with the same reference numerals. In the embodiment of FIG. 5, the reinforcement assembly 20 is generally the same as that described above and includes a circumferential clamp 22 and an anchor plate 24 connected by anchor rods 26. However, due to the small diameter of the pipe 14, the tie rods described above are not required. As such the anchor plate is secured to the vent pipe 62 with the nut 80.

As shown in FIG. 5, the first sealing means also differs from that shown in FIG. 1. Specifically, due to the smaller diameter of the pipe 14, the bearing plate 54 is replaced with a generally annularly shaped bearing disc 100. Disc 100 includes a generally central aperture through which extends the vent tube 62. The vent tube 62 includes a threaded outer surface at least proximal to the disc 100 so as to receive and engage a nut 102. Tightening of the nut 102 forces the disc 100 towards the sealing plate 48 thereby causing deformation of a resilient sealing member 104. To assist in forming the seal, the outer, resilient member contacting edge of the disc 100 may include a bevel, as shown in FIG. 6, to direct the sealing member radially outward against the inner wall of the pipe 14. The sealing member 104 may comprise an O-ring or the like.

In another embodiment, as illustrated in FIG. 7, the apparatus shown in FIG. 5 may be provided with a double seal. As shown in FIG. 7, an annular body 106 is provided between the sealing plate 48 and the bearing disc 100. The annular body is separated from the sealing plate 48 and the bearing disc 100 by resilient sealing members 104 (such as O-rings and the like). As the nut 102 is advanced on the vent pipe 62, the bearing disc compresses the assembly thereby causing the sealing members 104 to be deformed radially outwardly against the inner wall of the pipe being tested. As will be understood, this method of forming a double seal is similar to that described in reference to the apparatus of FIG. 1 with the exception that only a single nut (102) is used.

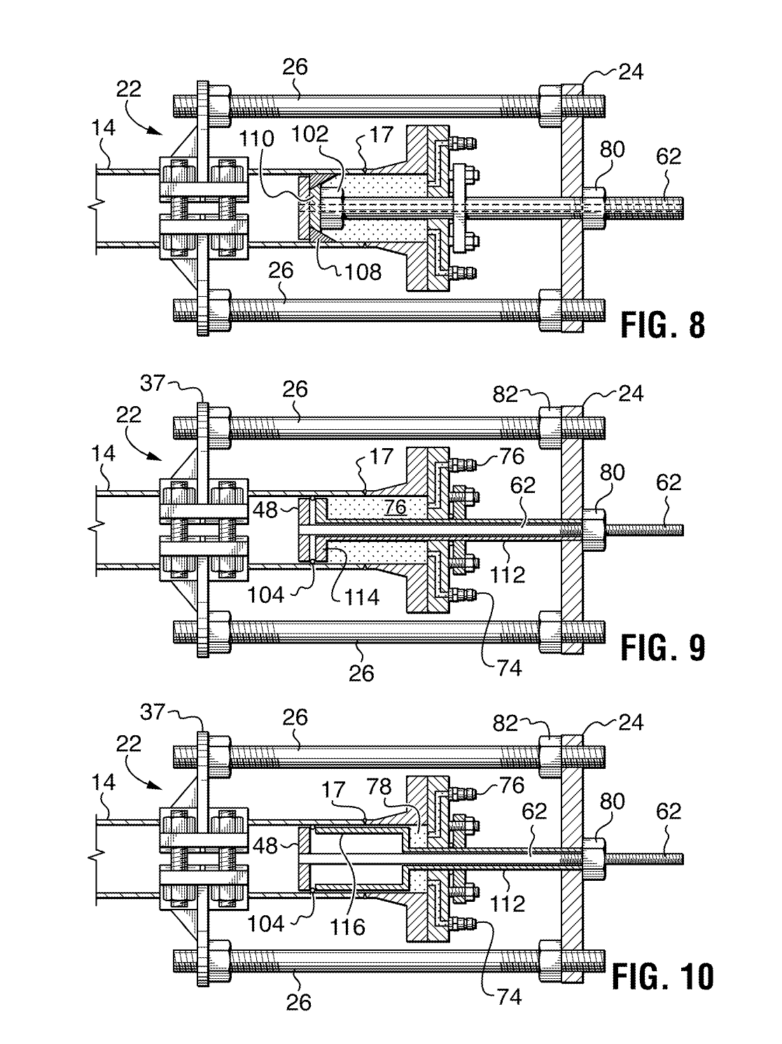

FIG. 8 is a further embodiment of the apparatus shown in FIG. 5 wherein identical elements are indicated with the same reference numerals. In this example, the resilient sealing member comprises a wedge-shaped body 108. In this case, the bearing disc 110 includes a bevel on the outer edge adjacent to the resilient member. As illustrated, the bevel on the bearing disc 110 is oppositely directed from the wedge of the resilient member. Thus, as will be understood by persons skilled in the art, as the nut 102 is advanced, the bearing disc 110 causes and outward expansion of the resilient member 108, thereby forming a seal with the inner wall of the pipe 14.

FIG. 9 illustrates another variation of the apparatus shown in FIG. 5 wherein identical elements are indicated with the same reference numerals. In this embodiment, the bearing disc 100 of FIG. 5 is replaced with a sleeve 112 provided coaxially over the vent pipe 62. The sleeve 112 includes on its upstream end, a bearing disc portion 114 that bears against a resilient sealing member 104. The downstream or external facing end of the sleeve extends through the opening in the anchor plate 24. As can be seen in FIG. 9, the tightening of the nut 80 causes upstream advancement of the sleeve and, therefore, causes the bearing disc portion 114 to bear against the resilient member 104. In the result, the resilient member 104 is deformed and radially expanded to form a seal against the pipe 14 inner wall. As described above, the outer, sealing member contacting edge of the bearing disc portion 114 may be provided with a bevel to ensure radial expansion of the resilient member. It will be understood that the embodiment of FIG. 9 may also be provided with an annular body 106 and an additional resilient member, as shown in FIG. 7, so as to form a double seal with the pipe inner wall.

FIG. 10 illustrates a further embodiment of the invention and a variant of the embodiment shown in FIG. 9. In FIG. 10, the sealing assembly again includes a sleeve 112 coaxially provided over the vent pipe 62. However, in the embodiment shown, the bearing disc portion is omitted and the sleeve 112 is instead provided with an increased diameter portion 116. As can be seen, the increased diameter portion 116 serves to occupy a majority of the volume of the test region 78 thereby reducing the amount of pressurizing fluid required for conducting the test. The upstream end of the increased diameter portion 116 impinges against a resilient sealing member 104 and may, as described above, be provided with a bevelled edge for encouraging a sealing engagement between the sealing member 104 and the pipe 14 inner wall. As in the embodiment shown in FIG. 9, advancement of the sleeve 112 against the resilient member 104 is accomplished by tightening of nut 80 provided on the vent pipe 62. Although the embodiment of FIG. 10 shows the use of a single resilient member, it will be understood that a double seal, as described above may also be used.

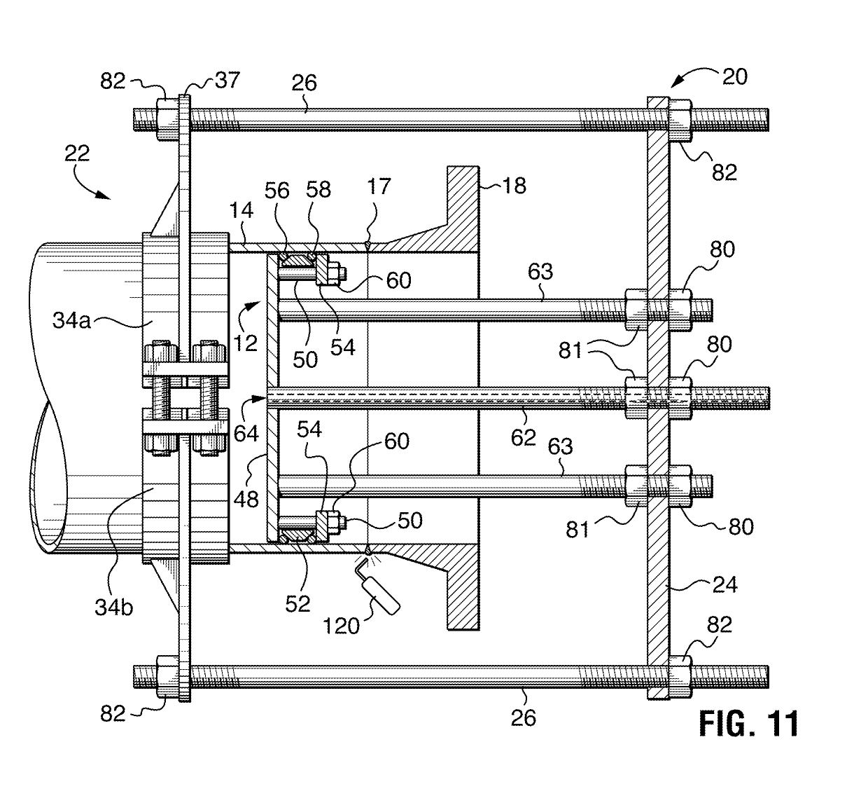

The above description has focussed primarily on the use of the apparatus of the invention for conducting a test on the weld 17 joining a flange 18 to the end of a pipe 14. However, the apparatus may also be adapted to allow a safe means of welding the flange 18 to the pipe 14 as well. This embodiment is illustrated in FIG. 11 wherein elements similar to those shown in previous figures are identified with like reference numerals. As shown, the reinforcement assembly 20 comprising the clamp 22 and anchor plate 24, joined together by the anchor rods 26 is the essentially the same as described above. However, it is noted that nuts 82 cooperating with the anchor rods 26 are placed on opposite sides of the support flange 37 and the anchor plate 24. Such orientation serves to place a compressive load on the anchor rods 26 wherein the anchor plate is urged towards the support flange 37 of the circumferential clamp 22. This orientation is opposite to that discussed above with reference to the weld testing method and the purpose of this is discussed further below.

As also shown in FIG. 11, only the first sealing means 12 is provided. As discussed further below, the second sealing means is not required. Specifically, the purpose of the apparatus shown in FIG. 11 is to isolate the end of the pipe 14 from the upstream portion thereof so as to allow the flange 18 to be welded to the end of the pipe. For this purpose, the first sealing means is inserted into the pipe and sealed to the interior wall thereof in the manner described above. That is, the first sealing means 12 is inserted into the pipe to a position upstream of the pipe end. The nuts 60 are then tightened so as to form a seal with the interior wall of the pipe 14. The first sealing means, once installed, therefore acts as a barrier to any fumes etc. present in the pipe 14. The vent pipe 62 serves to allow any such fumes to escape without interfering with the welding process (described below).

Once the first sealing means 12 is installed, the reinforcement assembly may then be installed in the same manner as described above. Namely, the circumferential clamp 22 is provided on the exterior surface of the pipe 14. The clamp 22 is preferably positioned a distance upstream from the first sealing means 12. Once the clamp 22 is secured to the pipe 14, the anchor rods 26 and anchor plate 24 are then placed into position as described above. More specifically, the anchor rods are provided into the respective openings on the support flange 27 of the clamp 22 and the anchor plate is then oriented so that the respective openings therein receive the anchor rods 26, the vent pipe 62 and, where present, the tie rods 63. The nuts 80 and 82 are then tightened so as to prevent any relative movement between the first sealing means 12 and the anchor plate 24 and between the anchor plate 24 and the clamp 22. The purpose of the reinforcement assembly is to prevent any dislodging of the first sealing means 12 in the event that fumes accumulate upstream of the first sealing means to a point where the vent pipe 62 is unable to prevent a pressure build-up. Thus, the combination of the vent pipe 62 and/or the tie rods 63 attached to the anchor plate prevent outward movement of the first sealing means. This is achieved by having the anchor plate 24 secured to the clamp 22.

Once the first sealing means 12 and the reinforcing assembly 20 are installed, the flange 18 may then be attached to the end of the pipe 14 by welding. A welding torch 120 is schematically illustrated in FIG. 11.

In one embodiment, the apparatus shown in FIG. 11 is preferably provided with a second set of nuts 81 that are positioned on the vent pipe 62 and tie rods 63 on the opposite face of the anchor plate 24. In other words, the nuts 81 are positioned opposite to the nuts 80 described above. As will be understood, the opposing nuts allow the apparatus to accommodate forces acting in both axial directions.

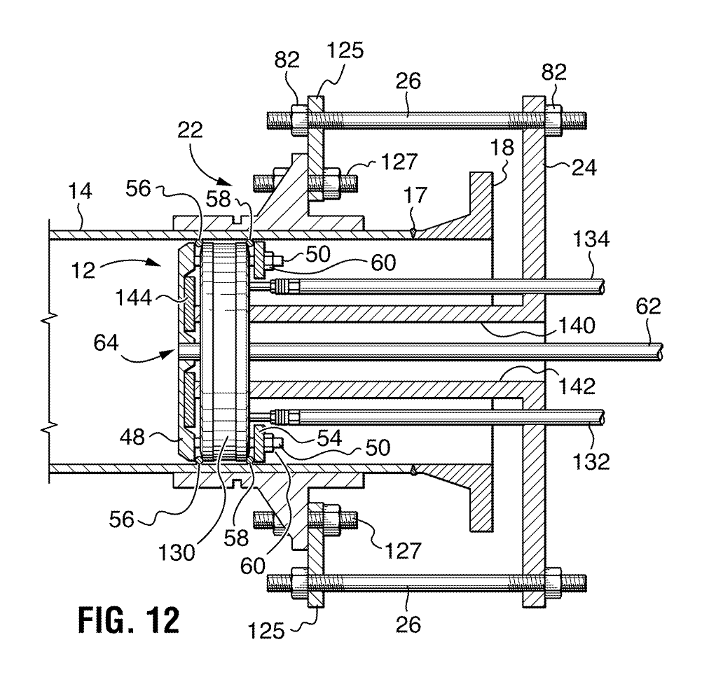

FIG. 12 illustrates a variation of the apparatus shown in FIG. 11. In FIG. 12, the reinforcement assembly comprising the circumferential clamp 22, anchor rods 26 and associated nuts 82, and the anchor plate 24 are the same as discussed above. It will be noted that the clamp is provided with a broader contact surface with the pipe 14 wall. It will be understood that a greater contact surface area results in increased frictional resistance to movement and, therefore, greater clamping force. The present invention is not limited to any specific size of the clamp 22 or the related components. FIG. 12 also illustrates a variation in the support flange referred to as element 37 in prior figures. In FIG. 12, the support flange comprises an annular plate 125 that is secured to the clamp 22 by means of bolts 127 and the associated nuts. In operation, the annular plate 125 functions the same as the support plate 37 of the previously described figures.

A first sealing means 12 is provided as discussed above. However, it is noted that the first sealing means in FIG. 12 includes an annular ring 130 that is fluidly connected to a fill port 132 and a vent port 134. The ports 132 and 134 extend through the annular ring 130 open into the outer wall thereof in a direction towards the pipe 13 inner wall (when the ring 130 is in position with the pipe 14). The arrangement of the first sealing means is essentially the same as the isolation/testing tool taught in the present applicant's prior U.S. Pat. Nos. 6,131,441 and 5,844,127. In operation, the first sealing means 12 is installed a described above. Namely, the various components are assembled either inside or outside of the pipe 14 and the nuts 60 are tightened to force the resilient sealing members 56 and 58 against the pipe 14 inner wall. As above, this results in a double seal being formed between the first sealing means 12 and the pipe 14 inner wall. At this point a pressurizing fluid is introduced into the fill port 132 and allowed to fill the volume bounded by the two resilient members 56 and 58, the outer wall of the annular ring 130 and the inner wall of the pipe 14. The vent port 134 serves to vent any air present in the volume. Once the volume is purged of air, the vent port 134 is closed and the volume is filled and pressurized. At this stage, the pressurized volume creates a third seal between the first sealing means 12 and the pipe 14 inner wall. As will be understood, a three part seal of this type serves to efficiently prevent any fumes etc. from passing through the first sealing means 12.

Further, by having the first sealing means secured to the reinforcement assembly, any axial displacement of the first sealing means is prevented.

In FIG. 12 a variation is shown in the manner in which the first sealing means is biased against the anchor plate. In the embodiments described above, the anchor plate of the reinforcing assembly was secured to the vent pipe and/or the tie rods. However, in the embodiment shown in FIG. 12, the anchor plate is provided with one or more extension arms. FIG. 12 illustrates two such reinforcement arms shown as 140 and 142, each being attached or integral with the anchor plate 24 and extending generally orthogonal thereto. The arms 140 and 142 are directed into the interior of the pipe 14. The arms 140 and 142 terminate at a bearing plate 144 that is biased against the sealing plate 48 of the first sealing means 12. In operation, the arms 140 and 142 serve in the same manner as the vent pipe and/or tie rods described above.

In another embodiment, the arms 140 and/or 142 may comprise a single tubular shaped body. In such case, it will be understood that the bearing plate 144 would preferably comprise an annular plate. Various other alternatives to the arms 140 and/or 142 will be apparent to persons skilled in the art.

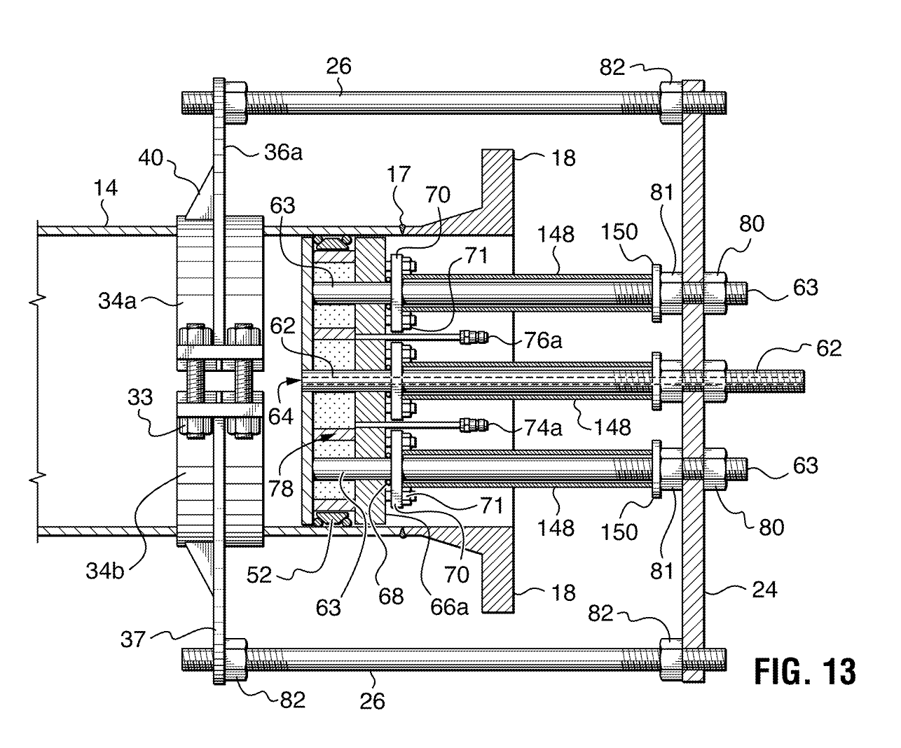

Another embodiment of the apparatus, which is a variation of the apparatus of FIG. 1, is illustrated in FIG. 13, wherein elements common to those of FIG. 1 are referred to with the same reference numerals. In the embodiment of FIG. 13, the blind flange, identified as element 66 in FIG. 1, is replaced by a variant shown as element 66a. In this case, as can be seen, the blind flange 66a is designed to be inserted within the lumen of the pipe 14. The inner face of the blind flange 66a (i.e. the face facing away from the flange 18) is adapted to be positioned adjacent to the annular ring 52 and cause compression and deformation of the resilient seals 56 and 58 in the same manner as the bearing plate 54 of FIG. 1. The function of the seals 56 and 58 is essentially the same as described above in connection with FIG. 1.

Advancement of the blind flange 66 against the seals 56 and 58 is achieved by means of transferring a compressive load exerted by nuts 81, associated with tie rods 63 and vent rod 62, on sleeves 148. As shown in FIG. 13, the sleeves 148 are adapted to be slidably and coaxially provided over each of the tie rods 63 and vent rod 62. One end of each sleeve is abuts the shaft seal plate 70 while the other end abuts the nut 81. In a preferred embodiment a washer 150 or the like may be provided between the sleeve 148 and the nut 81. As will be understood by persons skilled in the art, tightening of the nuts 81 will cause the sleeves 148 to be axially advanced against the seal plate 70. This in turn causes the seal plate 70 to bear against the blind flange 66a, thereby causing deformation of the resilient seals 56 and 58.

As can also be seen in FIG. 13, the vent and fill ports 74a and 76a are also similar to that shown in FIG. 1 but now may comprise a simple bore through the blind flange 66a.

The operation of the apparatus of FIG. 13 is essentially the same as that described for FIG. 1. The only difference being that nuts 81 are tightened (in the manner described above) to first create the circumferential seal between the seals 56, 58 and the pipe inner wall.

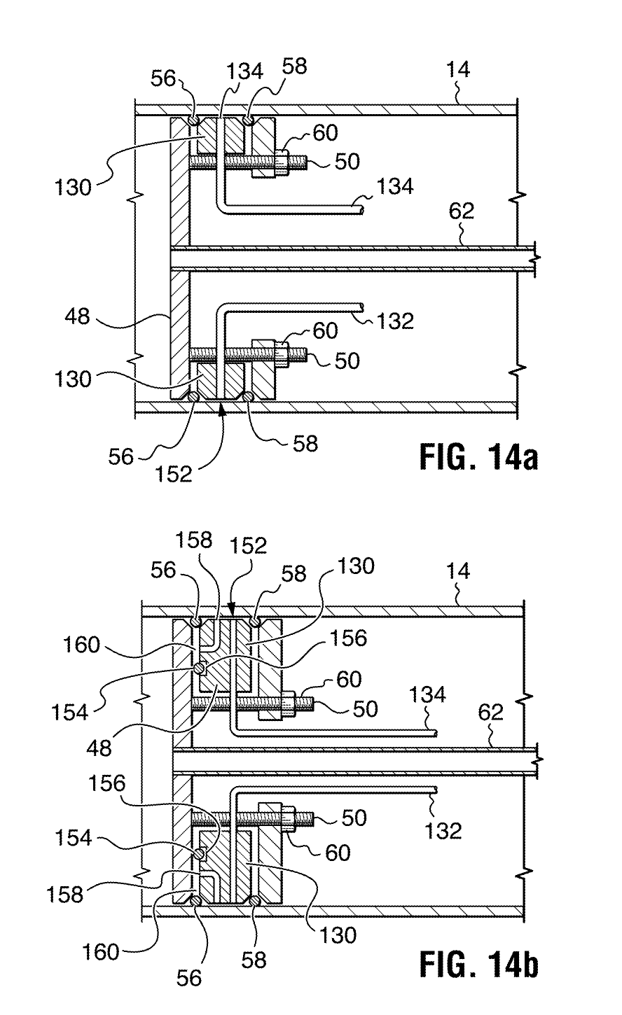

As indicated above with respect to FIG. 12, in one embodiment of the invention, a three stage sealing mechanism can be used wherein two seals formed by the resilient members or seals (such as O rings) are utilized along with a pressurized volume located between such seals. This type of sealing arrangement is schematically illustrated in FIG. 14a. As shown, the two seals 56 and 56 are deformed by tightening the nuts 60 thereby advancing a bearing plate 54 against the annular ring 130. The volume 152 formed between the pipe 14, the annular ring 130 and the seals 56 and 58 is then pressurized using ports 132 and 134.

In a variation of the arrangement shown in FIG. 14a, FIG. 14b also includes the same three stage sealing means but includes a further resilient member 154 that is located within a recess 156 provided on the annular ring 130. The recess 156 is provided on the face of the annular ring 130 that faces the sealing plate 48. In this way, as the annular ring 130 is advanced due to the tightening of the nuts 60, the resilient member 154 is compressed against the sealing plate 48 thereby forming a seal there-between. The annular ring 130 is further provided with one or more ports 158 that form a communication channel between the volume 152 and the annular space 160 formed between the annular ring 130, the sealing plate 48 and the seals 56 and 154. In operation, once the seals 56, 58 and 154 are formed, the volume 152 is pressurized as indicated above. In this process, the channel 158 causes a fourth pressurized volume comprising the annular space 160 to be formed. In this manner, the embodiment shown in FIG. 14b results in four seals. In one aspect, the invention provides a sealing apparatus as shown in FIG. 14b on its own to form an internal pipe sealing assembly. Such assembly will be understood as being usable with our without the axial reinforcement apparatus discussed above.

Although the invention has been described with reference to certain specific embodiments, various modifications thereof will be apparent to those skilled in the art without departing from the purpose and scope of the invention as outlined in the claims appended hereto. The disclosures of all prior art recited herein are incorporated herein by reference in their entirety.

We claim:

1. A weld testing apparatus for testing the integrity of a weld joining a flange to an end of a pipe, the apparatus, when in use, comprising:
a) a testing assembly comprising:
a first sealing means for forming a seal within the pipe;
a second sealing means for sealing the flange;
a means for pressurising a region bounded by the first sealing means, the second sealing means and the inner wall of the pipe;
and,
b) a reinforcement assembly for securing said testing assembly, the reinforcement assembly comprising:
a clamp secured to the outer wall of said pipe;
an anchor plate spaced apart from said clamp and positioned opposite the flange;
a first anchoring means connecting said anchor plate and said first sealing means for preventing separation between said anchor plate and said first sealing means; and
a second anchoring means connecting said anchor plate and said clamp for preventing relative movement there-between.

2. The apparatus of claim 1 wherein said testing assembly includes a vent extending there-through.

3. A method of testing the integrity of a weld joining a flange to an end of a pipe comprising:
securing a first sealing means within said pipe;
securing a second sealing means against said flange;
establishing a sealed region within said pipe bounded by said first and second sealing means and the inner wall of said pipe, said sealed region comprising the weld;
providing a clamp for frictionally engaging the outer wall of said pipe;
providing an anchoring means opposite said flange;
connecting the anchoring means to said clamp to prevent relative movement there-between;
connecting the anchoring means to said first sealing means to prevent relative movement there-between; and,
filling and pressurizing said sealed region with a testing fluid.

4. An apparatus for isolating an end of a pipe comprising:
a) an isolation assembly comprising:
a sealing means for forming a seal within the pipe;
and,
b) a reinforcement assembly for securing said isolation assembly, the reinforcement assembly comprising:
a clamp secured to the outer wall of said pipe;
an anchor plate spaced apart from said clamp and positioned opposite the end of the pipe;
a first anchoring means connecting said anchor plate and said sealing means for preventing axial displacement of said sealing means within the pipe; and
a second anchoring means connecting said anchor plate and said clamp for preventing relative movement there-between.

5. A method of isolating an end segment of a pipe comprising:
securing a sealing means within said pipe to isolate said end segment from the remaining interior portion of the pipe;
providing a clamp for frictionally engaging the outer wall of said pipe;
providing an anchoring means opposite said pipe end segment;
connecting the anchoring means to said clamp to prevent relative movement there-between;
connecting the anchoring means to said sealing means to prevent axial displacement of the sealing means within the pipe.
